(19) United States
(12) Patent Application Publication
(10) Pub. No.: US 2011/0266322 A1
(43) Pub. Date: Nov. 3, 2011

(54) SPORTS RACK AND METHOD

(76) Inventor: Timothy L. Jones, Colorado Springs, CO (US)

(21) Appl. No.: 12/917,958

(22) Filed: Nov. 2, 2010

Related U.S. Application Data
(60) Provisional application No. 61/261,588, filed on Nov. 16, 2009.

(51) Int. Cl. B60R 11/00

(52) U.S. Cl. 224/567

(57) ABSTRACT

The invention is directed to a sports rack or support system that has a pair of mounting posts adapted to be received in the stake holes of a pickup truck. A frame is supported by mounting posts. The frame includes a pair of laterally extending supports adapted to be positioned above the side rails and behind the cab when the mounting posts are in the stake holes. In one embodiment, the frame includes a first and a second frame elements. The frame elements have an arm that extends out along the side rail of the pickup truck. The laterally extending supports extend perpendicularly from the arms into the bed of the pickup truck. The laterally extending supports may be adjustable in length.

### RELATED APPLICATIONS

The present invention claims priority on provisional patent application, Ser. No. 61/261,588 , filed on Nov. 16, 2009, entitled “Rack for use with Pickup Trucks” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER

PROGRAM LISTING

Not Applicable

### BACKGROUND OF THE INVENTION

Racks for holding skis, bicycles, and other sports equipment on the bed of pickup trucks are known. Unfortunately, many of them are designed to hold just a single type of sports equipment. As a result, the owner has to have a separate sports rack for their bicycles, skis, kayak, canoe, surfboard, etc. In addition, many of the present sports racks are not adjustable and only work with certain models of pickup trucks.

Thus there exists a need for a sports rack for pickup trucks that can hold a variety of sports equipment and fits on a variety of models of pickup trucks.

BRIEF SUMMARY OF INVENTION

A sports rack that overcomes these and other problems has a pair of mounting posts adapted to be received in the stake holes of a pickup truck. A frame is supported by mounting posts. The frame includes a pair of laterally extending supports adapted to be positioned above the side rails and behind the cab when the mounting posts are in the stake holes. In one embodiment, the frame includes a first and a second frame elements. The frame elements have an arm that extends out along the side rail of the pickup truck. The laterally extending supports extend perpendicularly from the arms into the bed of the pickup truck. The laterally extending supports may be adjustable in length.

This sports rack is easy to install, since the frame elements have mounting posts that fit into the stake holes of the pickup truck. The adjustable length laterally supports allow the rack to work with different model pickup trucks. The rack provides a platform on which a variety of mounting devices can be easily attached.

BRIEF DESCRIPTION OF THE SEVERAL VIEWS OF THE DRAWINGS

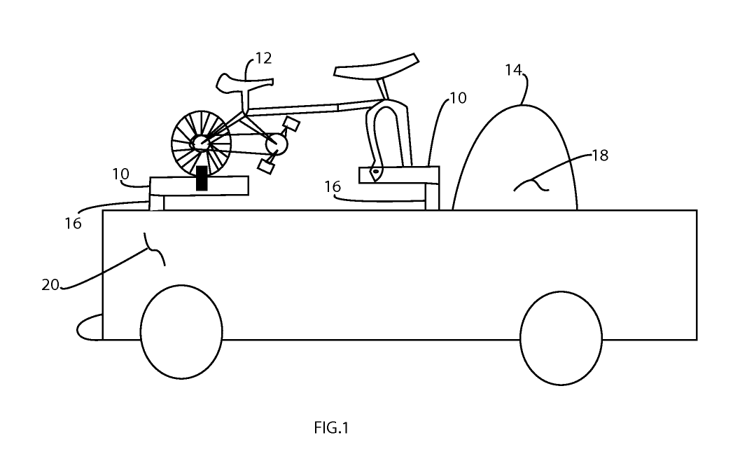

FIG. 1 is a side view of the sports rack holding a bicycle attached to a pickup truck in accordance with one embodiment of the invention;

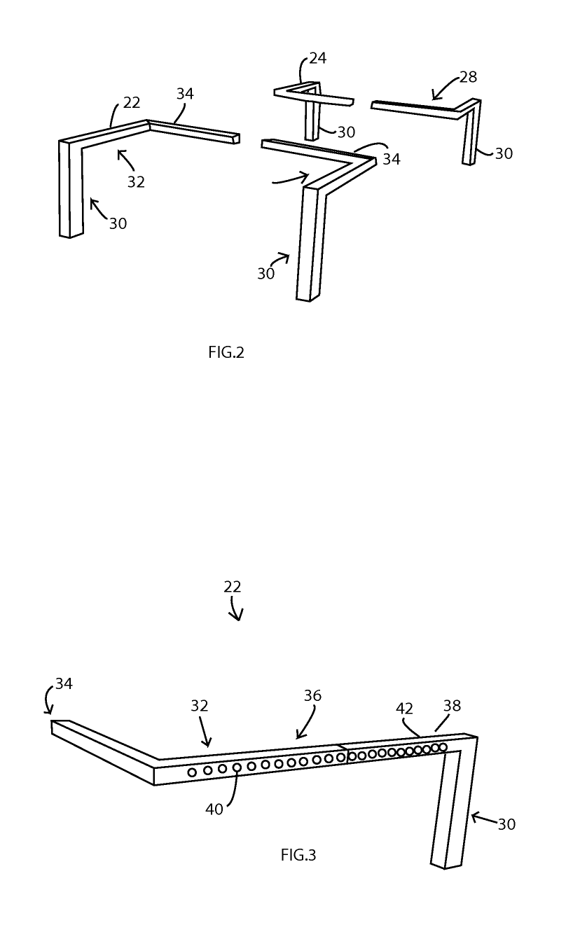

FIG. 2 is top right perspective view of the sports rack in accordance with one embodiment of the invention;

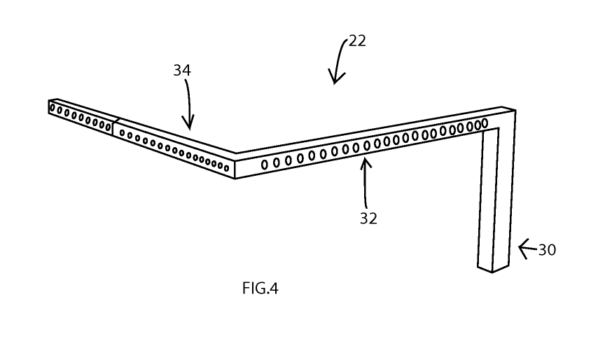

FIG. 3 is a perspective view of a frame element in accordance with one embodiment of the invention;

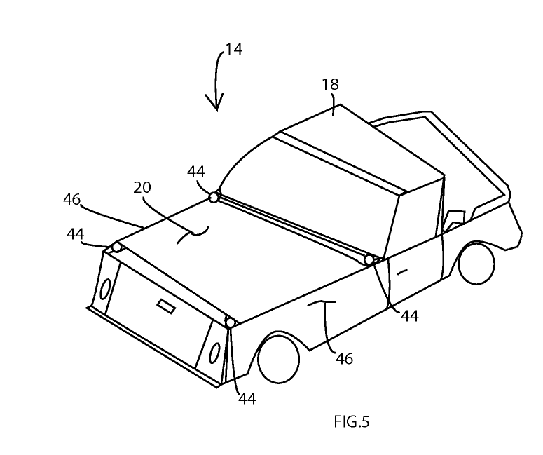

FIG. 4 is a perspective view of a frame element in accordance with one embodiment of the invention;

FIG. 5 is a perspective view of a pickup truck in accordance with one embodiment of the invention;

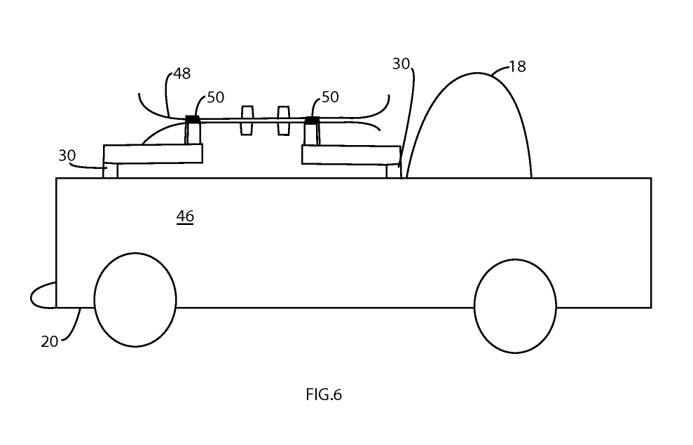

FIG. 6 is a side view of the sports rack holding skis attached to a pickup truck in accordance with one embodiment of the invention; and

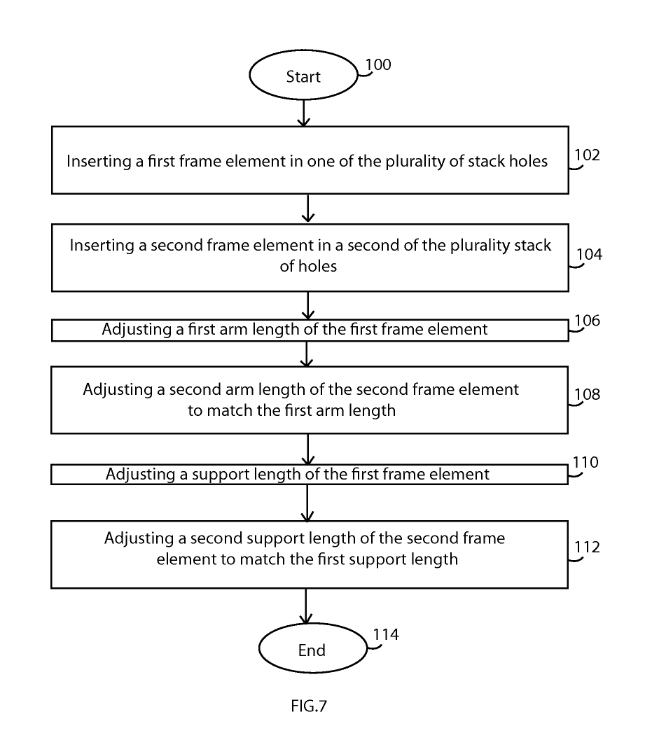

FIG. 7 is a flow chart of the steps used to install a sports rack in accordance with one embodiment of the invention.

### DETAILED DESCRIPTION OF THE INVENTION

The invention is directed to a sports rack or support system that has a pair of mounting posts adapted to be received in the stake holes of a pickup truck. A frame is supported by mounting posts. The frame includes a pair of laterally extending supports adapted to be positioned above the side rails and behind the cab when the mounting posts are in the stake holes. In one embodiment, the frame includes a first and a second frame elements. The frame elements have an arm that extends out along the side rail of the pickup truck. The laterally extending supports extend perpendicularly from the arms into the bed of the pickup truck. The laterally extending supports may be adjustable in length.

This sports rack is easy to install, since the frame elements have mounting posts that fit into the stake holes of the pickup truck. The adjustable length laterally supports allow the rack to work with different model pickup trucks. The rack provides a platform on which a variety of mounting devices can be easily attached.

FIG. 1 is a side view of the sports rack 10 holding a bicycle 12 attached to a pickup truck 14 in accordance with one embodiment of the invention. The sports rack 10 has a pair of mounting post 16 that fit inside the stake holes of the pickup truck 14. The pickup truck 14 is a conventional pickup truck 14 with a cab 18 and a bed 20 behind the cab 18.

FIG. 2 is top right perspective view of the sports rack 10 in accordance with one embodiment of the invention. In particular, FIG. 2 shows a pair of substantially identical truck racks 22 & 24 and 26 & 28, which can be used together at the same time on a single pickup truck. The racks are made up of a back frame element 22, 26 and a front frame element 24, 28. The racks mount in a low profile position over the bed of any pickup truck with a standard bed top stake holes or the like. The racks are each suitable for transporting skis, snowboards, bikes, kayaks, and other sport equipment (gear). Each rack allows easy access to the gear to a person standing firmly on the ground alongside the truck. There is no need for such a person to reach to the top of the cab of the truck while standing on the edge of the truck door frame or climb into the bed of a truck to retrieve gear. The racks also carry gear so at least a portion if not all of the gear is shielded by the cab from collision with debris when the truck is moving forward. Accordingly, the racks can be desirable alternatives to support systems that use a trailer hitch mount or a cab top rack design to support gear or simply placing loose equipment in the bed of their truck.

The racks 22 & 24 and 26 & 28 are made up of two mirror image frame elements. Each frame has a mounting post 30. An arm 32 extends from mounting post 30 in a perpendicular direction over the side rails of the pickup truck. A lateral support 34 extends perpendicularly from the arm 32 into the center of the truck bed. A variety of mounting devices may be attached to the lateral supports 34 to hold variety of equipment. The arm and lateral support are made of suitable material such as steal, aluminum, or other material able to support the expected loads.

Because the racks are substantially identical, a detail description of one of the racks will suffice to describe the both. Broadly, the rack comprises a support system adapted for supporting the gear above the side rails and behind the cab.

The support system of the rack is suitably constructed of hollow tubing made of steel, aluminum, or the like to provide a high strength light weight frame. The support system has a plurality of mounting posts 30 adapted to be received in the stake holes in one of the side rails of the truck. The mounting posts are suitable designed to fit the standard truck bed wall stake holes. The mounting post is suitably a segment of rectangular tubing with outer dimension that fit snugly in the stake holes and do not require additional hardware to stay in place. In one embodiment, a screw or locking mechanism (not shown) may be used to secure the mounting post 30 in the stake hole if desired. For example, a screw can be placed through the access hole (not shown) provided in the stake hole of the truck and extend into a tapped hole (not shown) on the mounting post 30. This allows the mounting post 30 to be secured to the truck via the existing holes conventionally provided on the inside of the pickup truck bed for securing items in the stake holes. Due to the varying positions of this access hole on different makes and models of truck, it is contemplated that the rack may be part of a kit (not shown) including one or more of a drill, tap, screw, and instructions for drilling and tapping a hole in the appropriate place on the mounting post and installing the rack on a truck.

Two exemplary mounting options for securing the rack to the bed of the truck are: 1) The use of a standard bolt, washer, and lock washer; and 2) The use of a tamper proof, custom designed security bolt, such as Bryce Fasteners Keyed-Lok™ or the Bryce Fasteners Key-Rex™ system, will prevent tampering with the bolt once in place. Both of the Bryce Fastener bolts mentioned above provide a special, customized bolt socket, with a custom socket for use with a ratchet system to secure the mount in the truck. The design will prevent the use of any standard socket head and will prevent the use of a pliers type device to unscrew the bolt and remove the rack from the truck. Those skilled in the art recognize that other fastening system, including but not limited to other fastening systems having security features to limit the ability of unauthorized persons to remove (e.g., steal) the rack form the truck, are within the scope of the invention.

FIG. 3 is a perspective view of a frame element 22 in accordance with one embodiment of the invention. The frame element 22 is the same as those shown in FIG. 2 except the arm 32 is adjustable in length. The length of the arm 32 is adjusted by having an exterior segment 36 and an interior segment 38 that slides inside the exterior element 36. Both segments 36, 38 have a plurality of holes 40, 42 placed periodically along their length. The exterior element 36 is slid along the interior element 38 until the desired length is created and then one the holes 40 of the exterior segment 36 is aligned with one of the holes 42 of the interior element 38. A bolt or quick release device is placed through the overlapping holes to secure the arm 32 at the desired length. An example of such a device includes Bryce Fastener Penta Nuts™ or a Kryptonite Kyrptoflex® 1565 Key cable. The ability to extend or retract one of both arms of the rack provides flexibility to increase or decrease the spacing between the lateral supports 34 and/or move the gear carried by the rack forward or backward relative to the truck.

FIG. 4 is a perspective view of a frame element 22 in accordance with one embodiment of the invention. This embodiment of the frame element 22 shows that not only is the length of the arm 32 adjustable, the length of the lateral support 34 is adjustable. This system for adjusting the length of the lateral support 34 is the same as for the arm 32, so the description will not be repeated. The ability to adjust the length of one or both of the lateral supports 34 provides flexibility to move the gear rack closer to the longitudinal centerline of the truck or closer to the side rail.

FIG. 5 is a perspective view of a pickup truck 14 in accordance with one embodiment of the invention. This view of the pickup truck 14 shows the stake holes 44 in the side rails 46. Stake holes 44 are common to many new pickup trucks.

FIG. 6 is a side view of the sports rack holding skis 48 attached to a pickup truck in accordance with one embodiment of the invention. The skis 48 are attached by a mounting bracket 50 to the rack. The skis are protected by the cab 18 and are easily accessible by a person standing on the ground.

FIG. 7 is a flow chart of the steps used to install a sports rack in accordance with one embodiment of the invention. The process starts, step 100, by inserting a first frame element in one of the plurality of stake holes at step 102. A second frame element of the rack is inserted into a second of the plurality of stake holes at step 104. Generally, the first and second frame elements are mirror images of each other. The two frame elements are generally inserted into a front and back stack holes on the same side rail. The first arm length is adjusted for the first frame element at step 106. The second arm length of the second frame element is adjusted to match the first arm length at step 108. Note in one embodiment, the first arm length and the second arm length are not the same. A lateral support length of the first frame element is adjusted at step 110. At step 112, the lateral support length of the second frame element is adjusted to be the same length as the first lateral support length, which ends the process at step 114. Note in one embodiment, the first lateral support length is not equal to the second lateral support length. The steps of the process do not necessarily have to occur in an specific order. For instance, the lateral support lengths may be adjusted first, then the frame elements may be installed in to the stake holes, and finally the arm lengths may be adjusted.

Thus there has been described a sports rack is easy to install, since the frame elements have mount posts that fit into the stake holes of the pickup truck. The adjustable length laterally supports allow the rack to work with different model pickup trucks. The rack provides a platform on which a variety of mounting devices can be easily attached.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A rack for using in transporting sports gear by a pickup truck having a cab, a bed behind the cab, and side rails extending away from the cab on the opposite side of the bed, wherein the side rails have stake holes, the rack comprising a support system for supporting the gear above the side rails and behind the cab, the support system comprising:
a pair of mounting posts adapted to be received in the stake holes; and
a frame supported by the mount posts, the frame comprising a pair of laterally extending supports adapted to be positioned above the side rails and behind the cab when the mounts are in the stake holes.

2. A rack as set forth in claims 1, wherein the support system comprises first and second frame elements, each frame element including one of the mounting posts and one of the laterally extending supports.

3. A rack as set forth in claim 2, wherein each frame element further comprises an arm connecting the mount to the laterally extending support.

4. A rack as set forth in claim 3, wherein the arm of at least one of the frame elements has an adjustable length.

5. A rack as set forth in claim 4, wherein the arms of the frame elements each have an adjustable length.

6. A rack as set forth in claim 3, wherein the laterally extending supports of the frame elements each have an adjustable length.

7. A rack as set forth in claim 6, wherein the arms of the frame elements each have an adjustable length.

8. A rack as set forth in claim 3, wherein the first and second frame elements are mirror images of one another.

9. A rack as set forth in claim 3, wherein the arm of each frame element is substantially perpendicular to the mounting post and substantially perpendicular to the laterally extending support.

10. A rack as set forth in claim 9, wherein the laterally extending supports for each frame element are substantially perpendicular to the respective mounting post.

11. A rack as set forth in claim 1 in combination with the pickup truck, the mounting posts being installed in the stake holes.

12. A rack as set forth in claim 11 in combination with a ski supported by the laterally extending supports in a position in which the ski is above the side rails, laterally inward from the side rails, and behind the cab such that the cab shields the skis from encountering debris when the truck is moving.

13. A rack as set forth in claim 11 in combination with a bicycle supported by the laterally extending supports in a position in which a bottom of the bicycle is above the side rails and below a top of the cab.

14. A rack as set forth in claim 1 in combination with at least one universal mounting bracket mounted on a respective one of the laterally extending supports.

15. A method of installing a rack on a pickup truck for carrying sports equipment, wherein the pickup truck has a plurality of stake holes in a pair of side walls of a bed of the pickup truck, comprising the steps of:
inserting a first frame element in one of the plurality of stake holes;
inserting a second frame element in a second of the plurality of stake holes; and
adjusting a first arm length of the first frame element.

16. The method of claim 15, further including the step of:
adjusting a second arm length of the second frame element to match the first arm length.

17. The method of claim 16, further including the step of:
adjusting a support length of the first frame element.

18. The method of claim 17, further including the step of:
adjusting a second support length of the second frame element to match the first support length.

19. The method of claim 15, further including
inserting a third frame element in a third of the plurality of stake holes.

20. The method of claim 19, further including
inserting a fourth frame element in a third of the plurality of stake holes.
